(19) United States
(12) Patent Application Publication
(10) Pub. No.: US 2004/0095377 A1
(43) Pub. Date: May 20, 2004

(54) Video information analyzer

(75) Inventor: Jerome R. Salandro, Gibsonia, PA (US)

Correspondence Address: MORGAN, LEWIS & BOCKIUS LLP, 1701 MARKET STREET, PHILADELPHIA, PA, 19103-2921, US

(73) Assignee: IRIS Technologies, Inc.

(21) Appl. No.: 10/298,457

(22) Filed: Nov. 18, 2002

(51) Int. Cl. H04N 5/91; G09G 5/00

(52) U.S. Cl. 345/723; 348/700

(57) ABSTRACT

Methods, systems, and means for receiving video input from a source device, marking reference points within the video input stream to demarcate video segments, assigning reference information to the video segments, storing the video input stream with the associated reference points and reference information in a video storage device, and analyzing video segments stored in the video storage device based upon the assigned reference information. Demarcating video segments from a video input stream enables more efficient searching for desired video segments. Assigning reference information to a demarcated video segment enables more efficient searching by providing a user with the ability to conglomerate similar video segments by performing a single search.

### BACKGROUND

1. Field of the Invention

The present invention generally relates to data processing systems and methods, and, more particularly, to a video information analyzer that indexes video data to allow a user to retrieve and playback in real-time and in user-selected order only those portions of the video data that match the user's specifications supplied during the video retrieval.

2. Description of Related Art

With the popularity of television and video recorders, many video broadcast schemes have been devised to give a user more control, flexibility and freedom over the video content the user watches. For example, in a video-on-demand system (which is a pointcast system) typically available in hotel rooms, a guest is allowed to select and view a movie that may differ from the programming that other patrons in the hotel are viewing at that particular time. As part of the hotel's customized video entertainment facility, the selected movie is played back on the guest's television without relaying it to television sets in those hotel rooms where guests have not selected the specific movie. Such a facility allows a guest to view the desired movie at leisure and in the privacy of the guest's own hotel room. However, video-on-demand provides no control to the viewer as to the sequence or selection of the video that is displayed once the video file is chosen.

A similar individualized movie selection and playback is possible over the Internet. In that case, a user may first subscribe to an online movie delivery service or may pay for the selected movie at the time of ordering without subscribing to the service. After accessing a designated website, the authorized user may select and download the desired movie or video clip from the website for later viewing on the user's desktop computer screen or on any other mobile video playback device (e.g., a mobile laptop computer or DVD (Digital Video Disk) player, or an MPEG (Moving Picture Experts Group)-enabled pocket PC (personal computer) or a handheld PC).

U.S. Pat. No. 5,610,653 to Abecassis describes a content-on-demand video delivery system that automatically tracks a viewer-defined target within a viewer-defined window of a video image as the target moves within the video image.

U.S. Pat. No. 5,859,662 to Cragun et al. and U.S. Pat. No. 5,561,457 to Cragun et al. describe a television presentation and editing system that uses closed captioning text to locate items of interest based on one or more keywords used as search parameters.

TiVo® is a hardware device that allows a user to store and scan through television broadcast programs. The TiVo® system provides the user with the ability to fast-forward, rewind, and pause video as it is sent to the system. However, TiVo® does not allow the user to demarcate, search, compile data concerning, and analyze segments of the video stream. Moreover, the TiVo® system does not permit the user to jump to specific reference points within the video input stream.

A need exists for a system that permits a user to modify the sequence or selection of the video input stream by assigning reference points when storing the digital video file. Furthermore, a need exists for a system that allows the user to create user-defined fields, in addition to system preset fields, to demarcate video segments in the stored digital video file. Moreover, it is desirable to have a system that allows a user to directly access a demarcated video segment by searching for and selecting the demarcated video segment from a list of all demarcated video segments or all demarcated video segments possessing specified reference information.

### SUMMARY

It is an object of the present invention to provide the ability to directly and quickly access portions of a video file.

It is an object of the present invention to provide the ability to search for and assemble one or more video segments matching user-specified search criteria.

In accordance with one aspect of the present invention, the above and other objects can be accomplished by the provision of a method of processing video information comprising specifying a plurality of fields to be used to classify the video information, wherein each of the plurality of fields contains one or more user-selectable values; receiving a video input containing the video information; marking the video input to divide the video input into a plurality of video segments; allowing a first user to specify the one or more user-selectable values for each of the plurality of fields; classifying each of the plurality of video segments into one or more of the plurality of fields using corresponding one or more user-selectable values specified by the first user for each field used for classification; and storing each classified video segment along with corresponding one or more user-selectable values in a database.

Preferably, the invention may further comprise receiving an input specified by a second user specifying the one or more user-selectable values for one or more of the plurality of fields; for each classified video segment, searching the database to identify one or more corresponding fields whose respective one or more user-selectable values match the input specified by the second user; and selecting each classified video segment for which each of the one or more corresponding fields has one or more user-selectable values matching the input specified by the second user for the corresponding field.

In accordance with one aspect of the present invention, the above and other objects may also be accomplished by a system for processing video information including a processor; a video source device which provides video input to the processor; a memory which is operatively coupled to the processor; and a computer program stored in the memory which executes in the processor and which includes a marker module configured to mark the video input, a storer module configured to store one or more video files containing the marked video input in the memory, and an analyzer module configured to analyze one or more video files stored in the memory.

In accordance with one aspect of the present invention, the above and other objects may be accomplished by a data storage medium containing a program code, which, upon execution by a processor in a video information analyzer, causes said processor to perform the following: specify a plurality of fields to be used to classify said video information, wherein each of said plurality of fields contains one or more user-selectable values; receive a video input containing said video information; mark said video input to divide said video input into a plurality of video segments; allow a first user to specify said one or more user-selectable values for each of said plurality of fields; classify each of said plurality of video segments into one or more of said plurality of fields using corresponding one or more user-selectable values specified by said first user for each said field used for classification; and store each classified video segment along with corresponding one or more user-selectable values in a database.

The present invention allows the user to assign potential values to user-defined fields for use in marking video input received by a video information analyzer, receive video input into the video information analyzer, separate the video input into video segments by assigning reference points to the video input, specify values for the user-defined and preset fields for each video segment, and store the video segments into a database. The video information analyzer may also store an index file in the database that is used to index the stored video segments.

The user may search the database based on one or more values for the user-defined or preset fields to retrieve video segments that match those values. The video segments that match the user-defined values may be displayed in a list format where an identifier represents each video clip or in a grid format where a number represents all video segments that match the listed criteria. If the video segments are grouped in the grid format, a list of the video segments corresponding to a gridpoint may be produced by selecting the number assigned to that gridpoint.

The video information analyzer may accept either analog or digital video input, including MPEG format. The video information analyzer stores data in a digital format. Depending on the user's desired quality for the stored video, the user may choose a resolution for the video segments before they are stored.

The user may mark reference points in video segments at different times. First, the user may mark reference points by placing a black screen in front of the camera as the video is filmed. Alternatively, the user may mark reference points as the video information analyzer receives the video input, but before video segments are stored in the video storage device. Finally, the user may mark reference points into video previously stored in the video storage device by loading the stored video into the video information analyzer and assigning reference points.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 depicts a flowchart of the data flow for loading and analyzing data according to an exemplary embodiment of the present invention;

FIG. 2 shows a block diagram of an exemplary embodiment of the present invention;

FIG. 3 illustrates a screenshot of the Main Menu screen for the Setup step in an exemplary embodiment of the present invention;

FIG. 4 illustrates a screenshot of the Edit Play Book screen for the Setup step in an exemplary embodiment of the present invention;

FIG. 5 illustrates a screenshot of the New Game screen for the Record step in an exemplary embodiment of the present invention;

FIG. 6 illustrates a screenshot of the Record and Breakdown screen for the Record step in an exemplary embodiment of the present invention;

FIG. 7 illustrates a screenshot of the Game Properties screen for the Record step in an exemplary embodiment of the present invention;

FIG. 8 illustrates a screenshot of the My Games screen for the Mark step in an exemplary embodiment of the present invention;

FIG. 9 illustrates a screenshot of the Full Video Play screen for the Mark step in an exemplary embodiment of the present invention;

FIG. 10 illustrates a screenshot of the Play Breakdown screen of the Breakdown step in an exemplary embodiment of the present invention;

FIG. 11 illustrates a screenshot of the Play Summary screen of the Analyze step in an exemplary embodiment of the present invention;

FIG. 12 illustrates a screenshot of the Play Search screen of the Analyze step in an exemplary embodiment of the present invention;

FIG. 13 illustrates a screenshot of the Play List screen of the Analyze step in an exemplary embodiment of the present invention; and

FIG. 14 depicts a diagram of a search grid used in an exemplary embodiment of the present invention.

### DETAILED DESCRIPTION

Reference will now be made in detail to the preferred embodiments of the present invention, examples of which are illustrated in the accompanying drawings. It is to be understood that the figures and descriptions of the present invention included herein illustrate and describe elements that are of particular relevance to the present invention, while eliminating, for purposes of clarity, other elements found in typical content-on-demand and video-on-demand systems.

It is worthy to note that any reference in the specification to “one embodiment” or “an embodiment” means that a particular feature, structure or characteristic described in connection with the embodiment is included in at least one embodiment of the invention. The appearances of the phrase “in one embodiment” at various places in the specification do not necessarily all refer to the same embodiment.

Note that the term “video” includes a video signal with or without its accompanying audio. Also, “audio-visual input” or “video input” are therefore used interchangeably.

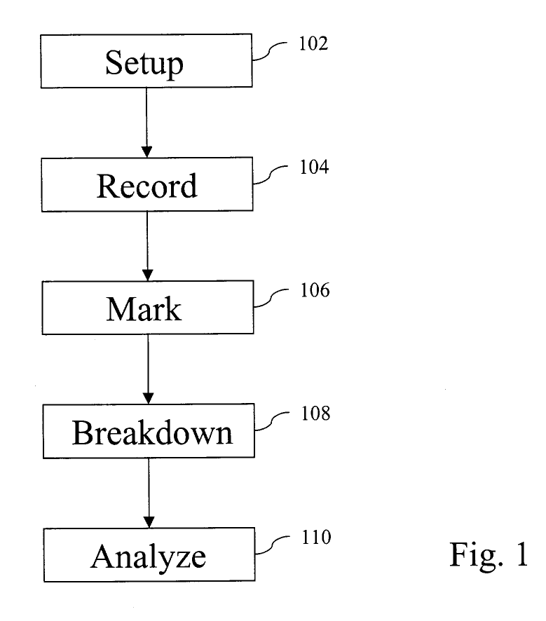

FIG. 1 depicts a flowchart 100 of the data flow for loading and analyzing data according to an embodiment of the present invention. In the exemplary embodiment, the flowchart includes five steps: Setup 102, Record 104, Mark 106, Breakdown 108, and Analyze 110. The Setup step 102 enables the user to define values that may be assigned to stored video segments. The Record step 104 allows the user to define user-selectable values that affect the process of receiving video input from a source device. Moreover, the Record step 104 allows video input to be received from a source device. The Mark step 106 enables the user to assign reference points within the received video input. By assigning reference points, the user demarcates the video input into distinct video segments. A video segment may be of the same length or of a different length as any other video segment. The Breakdown step 108 enables the user to classify each marked video segment based on preset and user-defined values. The Analyze step 110 allows the user to perform search operations based upon the preset and user-defined values assigned to video segments. Video segments may be stored in a video storage device during or after one or more of the Record 104, Mark 106, and Breakdown 108 steps.

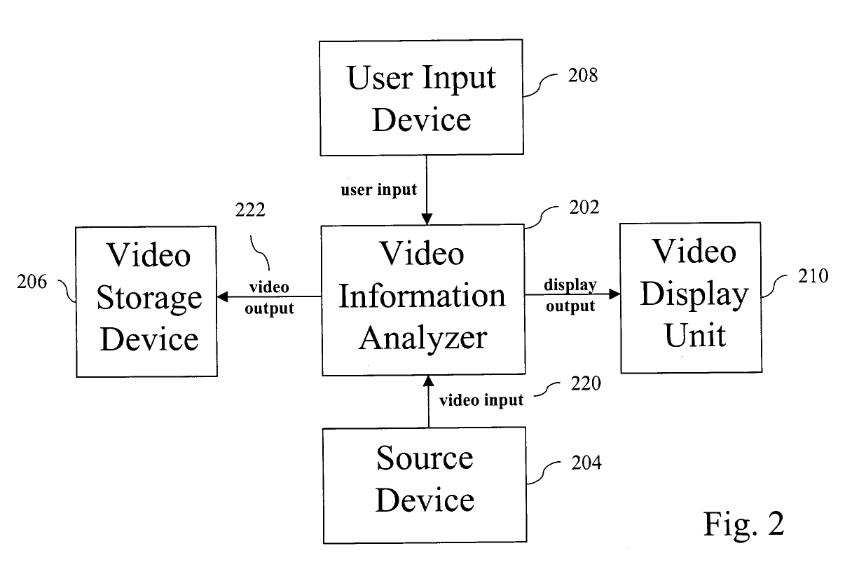

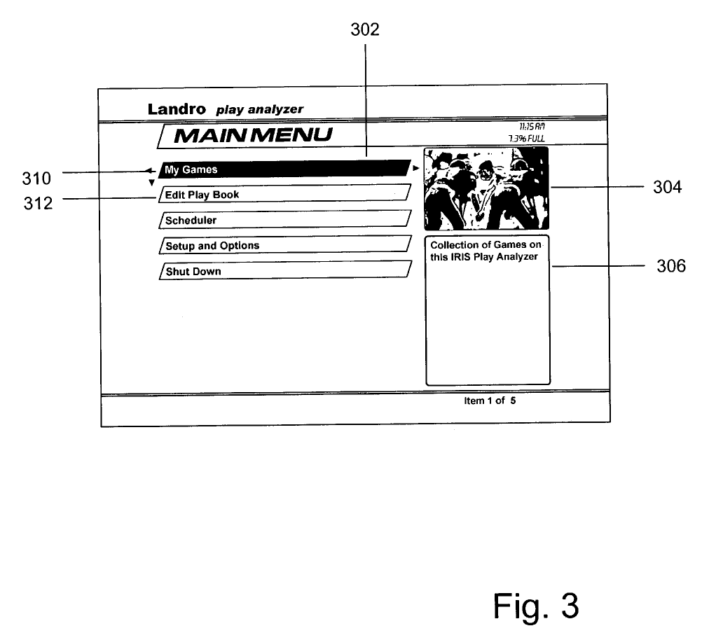

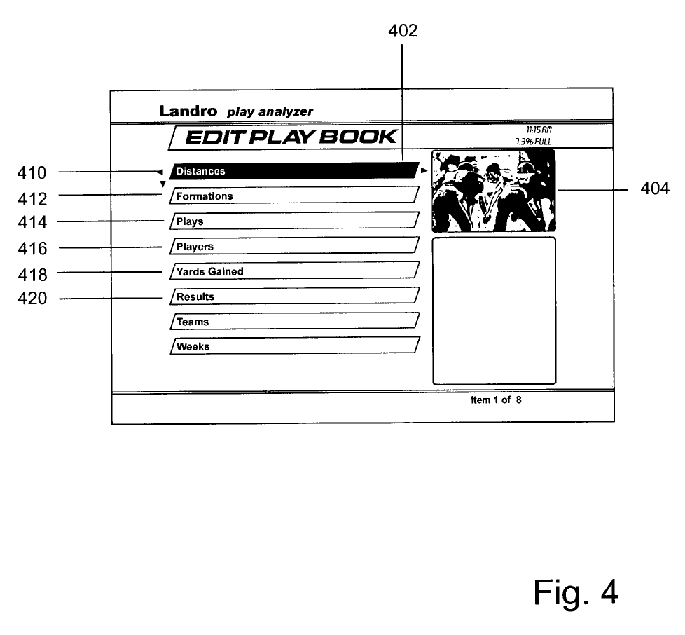

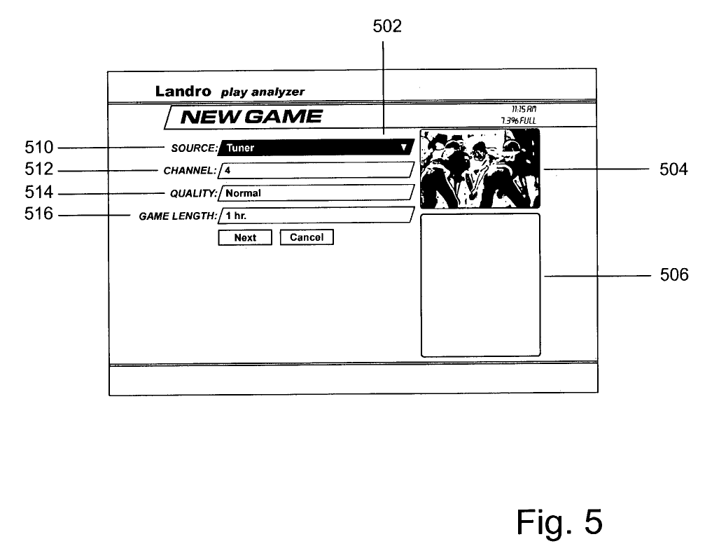

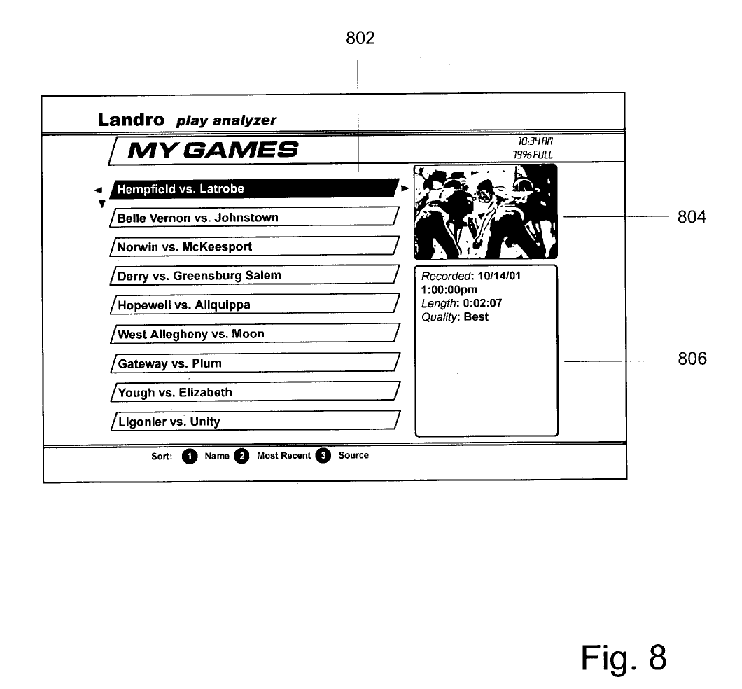

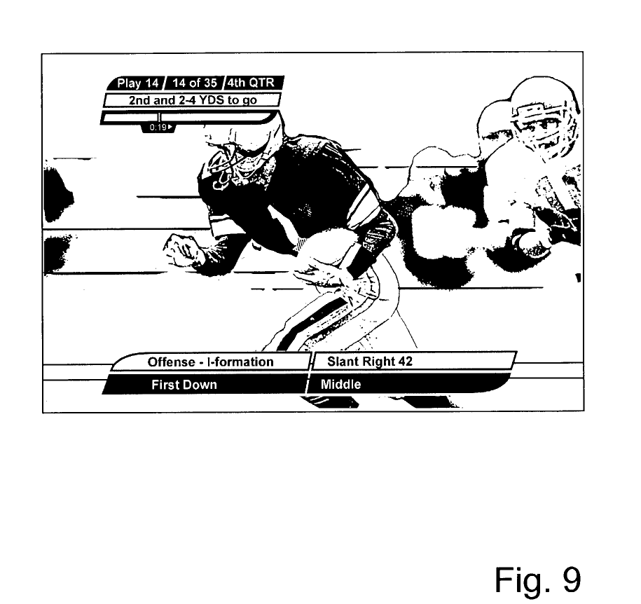

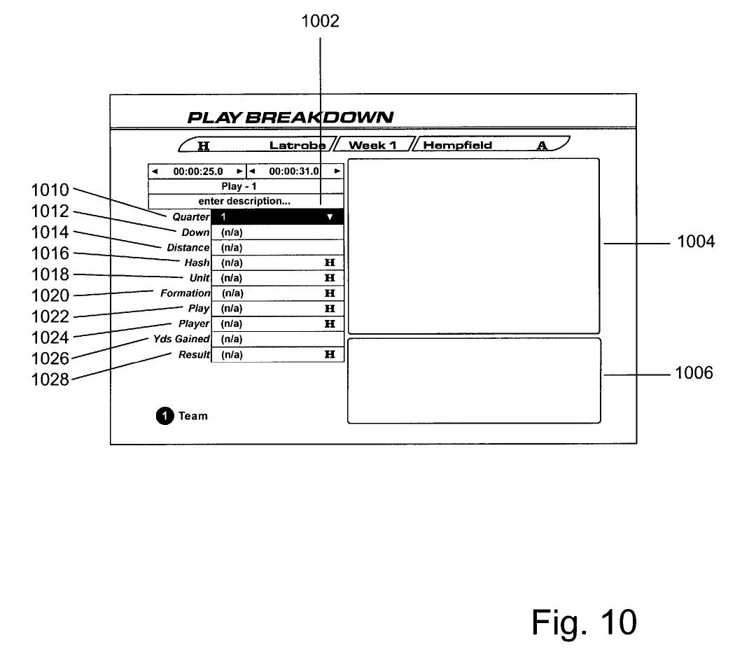

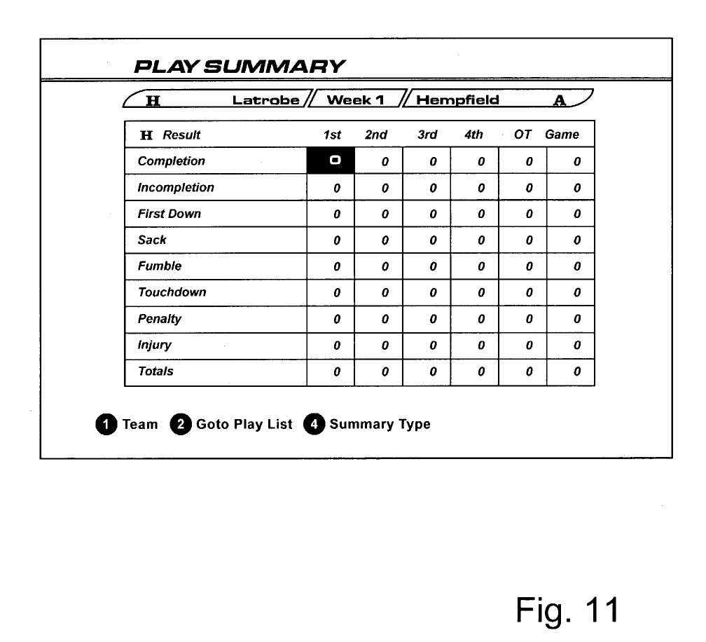

In a specific embodiment, a Video Information Analyzer 202 (as shown in FIG. 2) may be used to perform the above steps. In the embodiment, the Setup step 102 includes a Main Menu screen 300 and an Edit Play Book screen 400 in FIGS. 3 and 4, respectively. The Setup step 102 allows the user to set up all possible values that the user may assign to video segments for one or more fields. The user may choose different fields depending upon the content of the video input. The Record step 104 includes a New Game screen 500, a Record and Breakdown screen 600, and a Game Properties screen 700 in FIGS. 5, 6, and 7, respectively. The Record step 104 enables the user to define values such as the source of the video input, the length of time to receive video input, the resolution or quality at which to store video segments, and the format in which to store video segments. The Video Information Analyzer 202 then receives video input from the source device. The Mark step 106 includes a My Games screen 800 and a Full Video Play screen 900 in FIGS. 8 and 9, respectively. The Mark step 106 permits the user to mark reference points within the video input to denote the beginning and end of video segments. The Breakdown step 108 includes a Play Breakdown screen 1000 in FIG. 10. The Breakdown step 108 enables the user to assign values to the marked video segments. The values that may be assigned are either preset by the Video Information Analyzer 202 or defined by the user in the Setup step 102. The Analyze step 110 includes a Play Summary screen 1100, a Play Search screen 1200, and a Play List screen 1300 in FIGS. 11, 12, and 13, respectively. The Analyze step 110 permits the user to search for video segments that meet specified search criteria. The search criteria may include values assigned by the user in the Breakdown step 108.

FIG. 2 shows a block diagram 200 of an exemplary embodiment of the present invention. In the exemplary embodiment, the Video Information Analyzer 202 receives video input 220 from a Source Device 204 and sends video output 222 to a Video Storage Device 206. The Video Information Analyzer 202 may function in a combination of hardware and software. The Source Device 204 may include, but is not limited to, a video camera, a VCR, a DVD player, a CD player, a tuner, a television system, a cable television system, a satellite television system, or a computer. The video input 220 may be in analog and/or digital form (including, but not limited to, MPEG), and may be any combination of audio and video signals. The Video Storage Device 206 may include, for example, a digital video recorder, a CD-R drive, a VCR, a hard drive or other memory system, or a DVD player. The video output 222 may include, for example, a digital video output or an analog video output. A user may modify the contents of the Video Storage Device 206 and/or the video input 220 by means of a User Input Device 208 attached to the Video Information Analyzer 202. The User Input Device 208 may include, for example, a keyboard, a mouse, or any other selection and data entry device. The Video Display Unit 210 may be used, for example, to view, aid in editing, or aid in marking video data in the Video Information Analyzer 202. A Video Display Unit 210 may include, but is not limited to, a computer monitor, a television screen, a high-definition television screen, or an LCD screen.

In the embodiment described below, the Video Information Analyzer 202 is used to analyze video segments of football plays. It should be understood that this embodiment is not the only embodiment of the present invention and that the invention is not limited to the described embodiment. In other words, the Video Information Analyzer 202 may also be used to analyze videos of movies, other sporting events, television shows, etc.

FIG. 3 illustrates a screenshot of the Main Menu screen 300 for the Setup step 102 in an exemplary embodiment of the present invention. The Main Menu screen 300 may include, for example, the Main Menu 302 that has one or more corresponding menu items, the description box 304 that may provide text that describes a menu item selected by the user from the Main Menu 302, and the description box 306 that may provide text that describes a menu item selected by the user from the Main Menu 302. Through the Main Menu screen 300, a user may customize the Video Information Analyzer 202 and access the system information of the Video Information Analyzer 202 such as a list of previously stored video files.

A My Games menu item 310 is used to determine an appropriate subset of video data to access from the Video Storage Device 206. When a user selects the My Games menu item 310, the Video Information Analyzer 202 allows the user to access the My Games screen 800 as discussed herein below with reference to FIG. 8. An Edit Play Book menu item 312 permits the user to view and alter user-selectable values used to mark, search, and analyze video data stored in the Video Storage Device 206. When a user selects the Edit Play Book menu item 312, the Video Information Analyzer 202 permits the user to access the Edit Play Book screen 400 as discussed herein below with reference to FIG. 4.

FIG. 4 illustrates a screenshot of the Edit Play Book screen 400 for the Setup step 102 in an exemplary embodiment of the present invention. The Edit Play Book screen 400 may include an Edit Play Book menu 402 that has one or more corresponding menu items and a description box 404 that may display text describing a menu item selected by the user from the Edit Play Book menu 402. In an exemplary embodiment, the Edit Play Book menu 402 may include, but is not limited to, the following menu items: Distances 410, Formations 412, Plays 414, Players 416, Yards Gained 418, and Results 420.

In one embodiment, the Distances menu item 410 is used to indicate one or more yardage ranges that a team must gain in order to obtain a first down for a given video segment. In a specific embodiment, the user may assign up to ten distances and/or distance ranges by selecting the Distances menu item 410. The Formations menu item 412 is used to indicate one or more formations for a specific video segment. A formation refers to a specific alignment of players prior to the execution of a play. In a specific embodiment, a user may assign up to fifty entries by selecting the Formations menu item 412. The Plays menu item 414 is used to indicate one or more rehearsed patterns of action during the course of a video segment. A rehearsed pattern of action or a play refers to a sequence of movements performed by one or more players in a video segment. A play is scripted prior to its execution and prior to the process of filming. In a specific embodiment, a user may assign up to one hundred different plays by selecting the Plays menu item 414. The Players menu item 416 is used to indicate one or more players for a specific video segment. A player is a participant in a play. In a specific embodiment, a user may assign up to one hundred different players by selecting the Players menu item 416. The Yards Gained menu item 418 is used to indicate the number of yards gained during a specific video segment. In a specific embodiment, a user may assign up to ten different yardage ranges by selecting the Yards Gained menu item 418. The Results menu item 420 is used to indicate one or more outcomes for a specific video segment. In a specific embodiment, a user may assign up to forty different results by selecting the Results menu item 420.

Thus, a user may assign reference information such as one or more distances or distance ranges, one or more formations, one or more plays, one or more players on which to focus, one or more ranges of yardage gained, and one or more results in order to differentiate plays within a game. Each play may be tagged with one or more values of reference information during the Breakdown step 108. By assigning this information properly, the user may more efficiently perform analysis in the Analyze step 110 such as the efficiency of a play executed from one formation as compared to the efficiency of the same play executed from a different formation, the tendency of a team to use a specific play when the team is faced with certain down and distance parameters, the performance of a particular player on a given play, etc. Moreover, by assigning these values to each play, the user may quickly access similar plays by searching for all plays with a given value.

FIG. 5 illustrates a screenshot of the New Game screen 500 for the Record step 104 in an exemplary embodiment of the present invention. The New Game screen 500 may include, for example, a New Game menu 502 that has one or more corresponding menu items, a video inset window 504 that displays video segments from the game selected by the user from the New Game menu 502, and a description box 506 that may provide text that describes a game selected by the user from the New Game menu 502. In an exemplary embodiment, the New Game menu 502 may include, but is not limited to, the following menu items: Source 510, Channel 512, Quality 514, and Length 516.

The user may select an input source from the Source menu item 510 to inform the Video Information Analyzer 202 of the type of Source Device 204 to which it is connected. The user may select a channel value from the Channel menu item 512 to set the incoming channel when the Source Device 204 is, for example, a television system, a cable television system, or a satellite television system.

The Quality menu item 514 allows a user to customize quality settings for the output of a given video segment. In a specific embodiment, the quality settings may include, but are not limited to, Draft, Normal, High, and Best. The Draft setting represents a data resolution of 1.5 MB; the Best setting represents a data resolution of 6.0 MB. Video segments stored with lower resolution settings require less data storage space and permit more video segments to be stored on a given data storage medium. Video segments stored with higher resolution settings require more data storage space and permit fewer video segments to be stored on a given data storage medium. The data storage medium may include, for example, Random Access Memory (RAM), a floppy disk, a hard disk, a CD-RW disc, a DVD, or an optical disk. Data is stored in a database on the data storage medium. The data storage medium is or is accessed by the Video Storage Device 206.

The Length menu item 516 allows a user to determine the amount of time that the Video Information Analyzer 202 will accept video input 220 from the Source Device 204. In a specific embodiment, menu options may include: (1) Manual Stop, which allows the Video Information Analyzer 202 to record video input 220 from the Source Device 204 until a user manually stops recording, and (2) preset recording times from, for example, 15 minutes to, for example, 4 hours. If a user selects a preset recording time, the Video Information Analyzer 202 accepts video input 220 from the Source Device 204 from the moment recording begins until the specified preset time elapses. During this process, the video input 220 may be converted into either an analog or digital format and stored on the Video Storage Device 206. The video input 220 may also be marked with reference points prior to being stored on the Video Storage Device 206. Once the preset recording time elapses, the Video Information Analyzer 202 automatically stops receiving video input 220 from the Source Device 204.

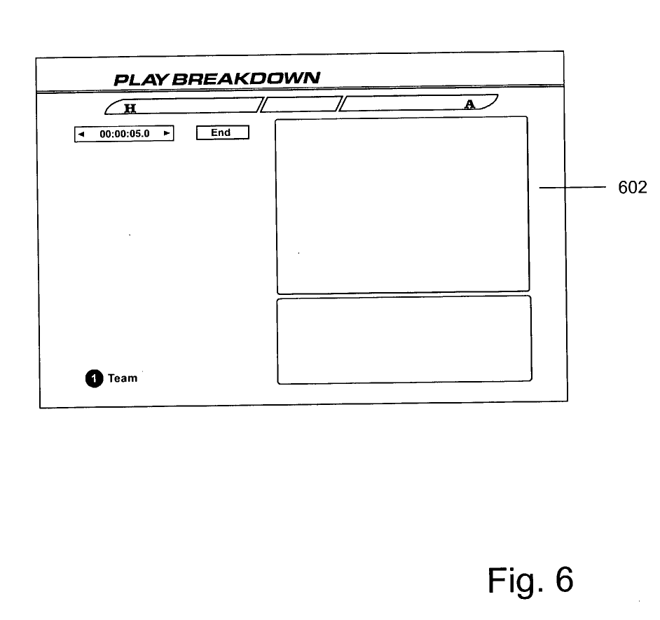

In an exemplary embodiment, two record modes may be used to record video input 220. A Record Only mode instructs the Video Information Analyzer 202 to record video input 220 from the Source Device 204. As the video input 220 is being recorded, the user either allows the Video Information Analyzer 202 to record for a time equal to a preset recording time or may, alternatively, mark the beginning and end points for video segments while the Video Information Analyzer 202 is recording. A Record and Breakdown mode, as implemented by the Record and Breakdown screen 600 depicted in FIG. 6, allows the user to record video input 220, set and select the user-selectable values that may be assigned to each video segment, play and mark the beginning and end points for each video segment from the video input 220, and Breakdown a video segment by assigning values to the user-selectable values for a given video segment. In one embodiment, the user may demarcate a video segment from the video input 220 to the Video Information Analyzer 202. While the Breakdown operation is performed on the marked video segment, a video inset window 602 displays the play in a loop so the user may properly assign values to it. Once the Breakdown operation is completed, the user instructs the Video Information Analyzer 202 to resume its recording of video input 220 from the Source Device 204. The Breakdown operation will be described in further detail with reference to FIG. 11.

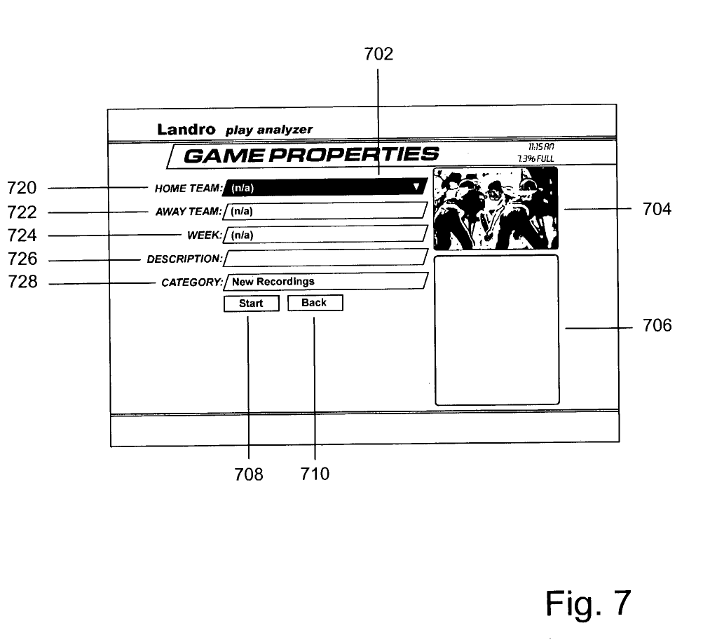

FIG. 7 illustrates a screenshot of the Game Properties screen 700 for the Record step 104 in an exemplary embodiment of the present invention. The Game Properties screen 700 may include, for example, a Game Properties menu 702 that has one or more corresponding menu items, a video inset window 704 that displays video segments from the game selected by the user from the Game Properties menu 702, a description box 706 that may provide text that describes the game selected by the user from the Game Properties menu 702, a Start button 708, and a Back button 710. In an exemplary embodiment, the Game Properties menu 702 may include, but is not limited to, the following selections: Home Team 720, Away Team 722, Week Number 724, Game Description 726, and Category 728.

The Home Team selection 720 permits the user to input text to denote the home team for one or more video segments. The Away Team selection 722 permits the user to input text to denote the visiting team for one or more video segments. The Week Number selection 724 permits the user to assign a week number to a given video segment. The week number refers to the week during the season in which the game was played. The Game Description selection 726 permits the user to input text to denote the video segment that is being recorded. In an embodiment, the text entered into the Game Description selection 726 is used on the My Games screen 800, as depicted in FIG. 8, to allow access to the stored video segments corresponding to each game. The Category selection 728 permits the user to input text to denote a category for the video segment that is being recorded. A user may use one or more categories to organize the video files stored on the Video Storage Device 206 for easy retrieval. For example, stored video files may be categorized by year, opponent, or whether the video file is of a game or a practice. In an embodiment, each stored video file corresponds to a game listed on the My Games screen 800. Each of the Home Team 720, Away Team 722, Week Number 724, Game Description 726 and Category 728 selections may be assigned a value prior to receiving video input 220 from the Source Device 204. Moreover, each of the above selections may have its value assigned or modified during or after the time when the video segments are stored in the Video Storage Device 206.

In an exemplary embodiment, the Start button 708 allows a user to begin recording video input 220 from the Source Device 204 once the user has assigned one or more of the Home Team 720, Away Team 722, Week Number 724, Game Description 726 and Category 728 selections to the video input 220. The Back button 710 allows a user to return to the New Game screen 500 from the Game Properties screen 700.

Thus, the user may define the source of the video input 220, the quality of the stored video file, and the method of recording a video file. The Record Only mode may be used, for example, to record a video file from the Source Device 204 to the Video Storage Device 206 when the user does not have time to breakdown the video file, but wishes to examine it in the future. The Record and Breakdown mode may be used to save time by demarcating the video file into video segments before it is stored in the Video Storage Device 206. The Record and Breakdown mode saves time for the user because the video file is only loaded into the Video Information Analyzer 202 once. Assigning file reference information such as the team names, week of the game, description of the game, and a game category permits the user to more efficiently find a game located on the Video Storage Device 206 during the Breakdown 108 or Analyze 110 steps. Thus, a user could request only games from a specific week to limit the number of games displayed on the My Games screen 800. This may be used to make the search for a particular game more efficient.

FIG. 8 illustrates a screenshot of the My Games screen 800 for the Mark step 106 in an exemplary embodiment of the present invention. The My Games screen 800 may include, for example, a Games menu 802 that has one or more corresponding menu items, a video inset window 804 that displays video segments from the currently selected game, and a description box 806 that may provide text that describes a highlighted menu item. In an exemplary embodiment, the Games menu 802 may include one or more text entries. Each of the text listings in the Games menu 802 corresponds to one or more user-defined text sequences entered into the Game Description field 726 on the Game Properties screen 700. Thus, each text listing or entry may be used to identify a group of video segments.

In a specific embodiment, a user may perform one or more of the following operations: Record, Sort, Analyze, and Play. The user may choose to Record a new game. If the Record option is selected, the New Game screen 500 is accessed from which the user may record a new game from the Source Device 204 through the Video Information Analyzer 202 to the Video Storage Device 206.

The user may choose to Sort the listed menu items by user-selectable values such as Week Number 724, Game Description 726, creation date, etc. When the Sort operation is performed, the list is sorted in either ascending or descending alphabetical or numerical order based on the user-selectable value that is listed.

The user may choose to Analyze the video segment associated with a menu item. Selecting the Analyze option allows the user to search through stored video data for video segments meeting one or more criteria. This operation will be described in more detail with reference to FIGS. 11-13.

The user may choose to Play the video segments associated with one or more menu items. When the Play option is selected, the Full Video Play screen 900 is opened. The Full Video Play screen displays the video segments associated with the selected menu items. In an embodiment, when the Full Video Play screen 900 is open, the user may Control or Mark the video segment.

Controlling the video segment includes the ability to fast-forward, rewind, pause, and jump to a specific video segment. Moreover, fast-forwarding and rewinding may be performed at one or more frame rates. The frame rate refers to the speed with which the video segment is shown. One or more informational displays may overlay the video segments on the Full Video Play screen 900. An informational display may be, for example, a display containing general game-related statistics, such as text identifying a video segment and the playback position, or a display containing play-related information, such as the formation, unit, results, play description, result, and player.

Marking may define the beginning and end of video segments from the video input 220. Once Marking has been performed, the user may instantly access a specific video segment by selecting the listing of the video segment from a list of one or more video segments. This provides a means for a user to access a particular video segment without fast-forwarding and rewinding through the entire saved video file containing the video segment. Moreover, Marking defines the boundaries of each video segment so that video-segment-specific information is displayed for the proper video segment. In an embodiment, Marking may be performed at one of three times: when the Source Device 204 sends video input 220 to the Video Information Analyzer 202, during review of a video file stored on the Video Storage Device 206, or during the filming of the video sequence. In the third case, Marking may be performed by flashing a black card in front of the camera. In the present invention, the black screen generated by the black card is recognized as a video signal interruption. The Video Information Analyzer 202 automatically marks the beginning and end points of the corresponding video segment when video signal interruptions are recognized.

FIG. 10 illustrates a screenshot of the Play Breakdown screen 1000 of the Breakdown step 108 in an exemplary embodiment of the present invention. The Play Breakdown screen 1000 may include, for example, a Play Breakdown menu 1002 that has one or more corresponding menu items, a video inset window 1004 that displays the video segment of the play selected by the user from the Play Breakdown menu 1002, and a description box 1006 that may provide text that describes the play selected by the user from the Play Breakdown menu 1002. The Play Breakdown menu 1002 is used to assign play reference information to video segments. Play reference information refers to values that define relevant characteristics of an individual video segment. Play reference information may be used to aid in the search for or analysis of a particular play. In an embodiment, the play reference information that may be assigned by the Play Breakdown menu 1002 corresponds to the following menu items: Quarter 1010, Down 1012, Distance 1014, Hash 1016, Unit 1018, Formation 1020, Play 1022, Player 1024, Yards Gained 1026, and Result 1028.

The Quarter menu item 1010 indicates the quarter in which the specific play in the video segment took place. The selections in the Quarter menu item 1010 are preset in the Video Information Analyzer 202. In an embodiment, the selections listed in the Quarter menu item 1010 include 1st (the first quarter), 2nd (the second quarter), 3rd (the third quarter), 4th (the fourth quarter), and OT (overtime).

The Down menu item 1012 indicates the down on which the specific play in the video segment took place. The selections in the Down menu item 1012 are preset in the Video Information Analyzer 202. In an embodiment, the selections listed in the Down menu item 1012 include 1 (for first down), 2 (for second down), 3 (for third down), and 4 (for fourth down).

The Distance menu item 1014 indicates the distance that the offensive team in the video segment must gain to obtain a first down. The user defines the selections for the Distance menu item 1014 by entering the selections into the Distances menu item 410 of the Edit Play Book screen 400.

The Hash menu item 1016 indicates the hash mark for either the Home Team or the Away Team. The hash mark refers to the position on the football field at which the football rests prior to execution of a play. The selections in the Hash menu item 1016 are preset in the Video Information Analyzer 202. In an embodiment, the selections listed in the Hash menu item 1016 include Left (for when the ball is positioned on the left hash mark), Middle (for when the ball is positioned on neither hash mark), and Right (for when the ball is positioned on the right hash mark).

The Unit menu item 1018 indicates the particular unit that was on the field during the current video segment for either the Home Team or the Away Team. The selections in the Unit menu item 1018 are preset in the Video Information Analyzer 202. In an embodiment, the selections listed in the Unit menu item 1018 include Offense (for when the play features the offensive unit), Defense (for when the play features the defensive unit), and Special Teams (for when the play features the special teams unit).

The Formation menu item 1020 indicates the formation of the unit for either the Home Team or the Away Team for the current video segment. The unit specified for the Formation menu item 1020 may either be the same as or different from the entry specified for the Unit menu item 1018. The user sets the selections for the Formation menu item 1020 by entering the selections into the Formations menu item 412 of the Edit Play Book screen 400.

The Play menu item 1022 indicates the rehearsed pattern of action for each player on the field during the course of the current video segment. A rehearsed pattern of action (a play) refers to a sequence of movements performed by one or more players in a video segment. A rehearsed pattern of action is generally scripted prior to its execution and prior to the process of filming. The user sets the selections for the Play menu item 1022 by entering the selections into the Plays menu item 414 of the Edit Play Book screen 400.

The Player menu item 1024 indicates one or more players for whom the user associates the current video segment. In an embodiment, the user may choose one or more players by selecting the player through a corresponding checkbox associated with a list of available players defined in the Players menu item 416 of the Edit Play Book screen 400. Assigning video segments to one or more particular players permits searching for player-specific video segments.

The Yards Gained menu item 1026 indicates the number of yards gained on the play in a particular video segment. The user sets the selections for the Yards Gained menu item 1026 by entering the selections into the Yards Gained menu item 418 of the Edit Play Book screen 400. In an embodiment, each selection in the Yards Gained menu item 1026 may be defined as a range of yardage or as a specific number of yards. For example, the Yards Gained menu item entries may be defined as less than 1 yard, 1 to 3 yards, 4 to 6 yards, 7 to 10 yards, 10 to 15 yards, and more than 15 yards. All yardage ranges are measured as the distance between the yardage line at which the play began execution and the yardage line at which the play terminated.

The Results menu item 1028 indicates the various results of the play in the current video segment. Results may include achieving a first down, scoring a touchdown, being sacked, being penalized, etc. The user sets the selections for the Results menu item 1028 by entering the selections into the Results menu item 420 of the Edit Play Book screen 400. In an embodiment, a user may indicate particular results by selecting a checkbox associated with a specific player.

Thus, the Breakdown step 108 is performed on marked video segments to assign reference information to a particular video segment. The Breakdown step 108 may be performed in conjunction with the Record step 104 and the Mark step 106 if the user is assigning reference points as the video input 220 is being recorded by the Video Information Analyzer 202. Alternatively, the Breakdown step 108 may be performed on a stored video file in the Video Storage Device 206. In this case, the user selects a game from the My Games menu 800 and assigns values to one or more of the demarcated video segments associated with the game. The assigned values are chosen from the Play Breakdown menu 1002 on the Play Breakdown screen 1000, and may include the quarter in which the play in the video segment took place, the down on which the play in the video segment took place, the distance away from a first down at which the play started, the hash mark on which the play started, whether the offense, defense, or special teams unit is on the field, the formation the play in the video segment was run from, the play that was run in the video segment, one or more players whose actions are of special interest, the yardage gained on the play in the video segment, and any results that the user may wish to record. The values assigned to a video segment may be used during the Analyze step 110 to efficiently search for video segments and to analyze similar video segments.

FIG. 11 illustrates a screenshot of the Play Summary screen 1100 of the Analyze step 110 in an exemplary embodiment of the present invention. The Play Summary screen 1100 displays an array of gridpoints, where each gridpoint contains an integer corresponding to the number of video segments for which a particular user-defined value is met in each quarter and in the entire game. A user can view the video segments corresponding to each gridpoint by selecting the gridpoint. In an embodiment, the axes for the array are: (1) preset Quarter values (for example, “1” for the first quarter, “2” for the second quarter, “3” for the third quarter, and “4” for the fourth quarter, and “OT” for the overtime period) and the total (i.e., the total number of plays in all quarters and the overtime period) in the x-direction; and (2) the values of a user-selected field in the y-direction. For example, if the user-selected field in the y-direction is the Down field, which is associated with the Down menu item 1012 in the Play Breakdown menu 1002 on the Play Breakdown screen 1000, then the first row would contain the number of video segments assigned a first down value that occurred in the first quarter in the first column, the number of video segments assigned a first down value that occurred in the second quarter in the second column, etc. Similarly, all video segments assigned a second down value would appear in the second row in the column corresponding to the appropriate quarter, etc. Finally, the number in the last position of each row would equal the number of video segments that had the down value corresponding to that row.

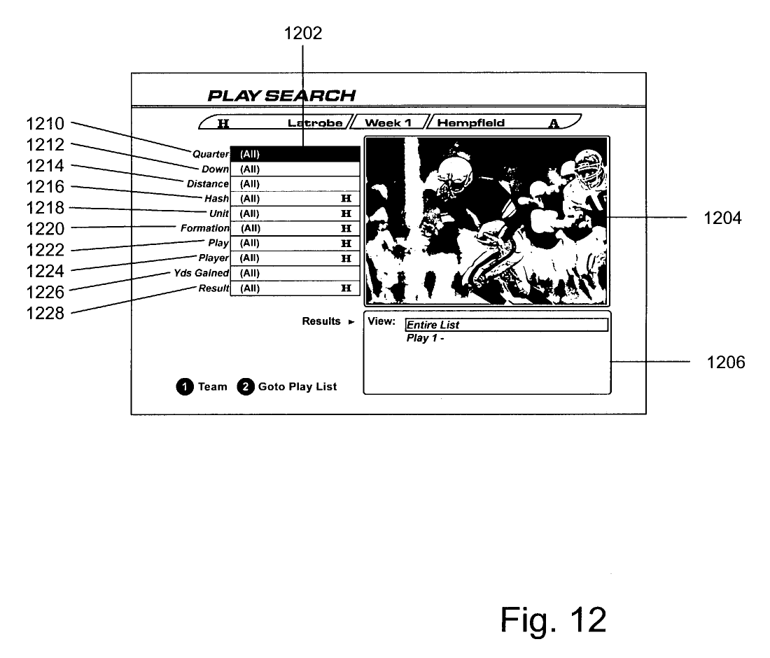

FIG. 12 illustrates a screenshot of the Play Search screen 1200 of the Analyze step 110 in an exemplary embodiment of the present invention. The Play Search screen 1200 may include, for example, a Play Search menu 1202 that has one or more corresponding menu items, a video inset window 1204 that displays the currently selected video segment, and a Results list 1206 that provides a list of the video segments assigned user-selected values that meet a set of search criteria. The user enters search criteria into the Play Search menu 1202 in order to produce the Results list 1206.

The Play Search menu 1202 may include one or more of the following search criteria: Quarter 1210, Down 1212, Distance 1214, Hash 1216, Unit 1218, Formation 1220, Play 1222, Player 1224, Yards Gained 1226, and Result 1228. These search criteria each correspond to the menu item of the same name described in reference to the Play Breakdown screen 1000 above. However, here the search criteria are used to select plays that were assigned values by the user during the Breakdown step 108. In addition, each search criterion provides the user with an option to select ALL possible values for the particular search criterion. In an embodiment, selecting ALL possible values is the default option. This option excludes no video segments based upon the particular menu item.

The Results list 1206 lists the plays that satisfy the search criteria chosen from the Play Search menu 1202 by the user. Each play in the Results list 1206 may be selected to view its corresponding video segment. In an embodiment, all video segments that satisfy the selections made by the user in the Play Search menu 1202 may be selected for viewing by selecting an Entire List selection in the Results list 1206.

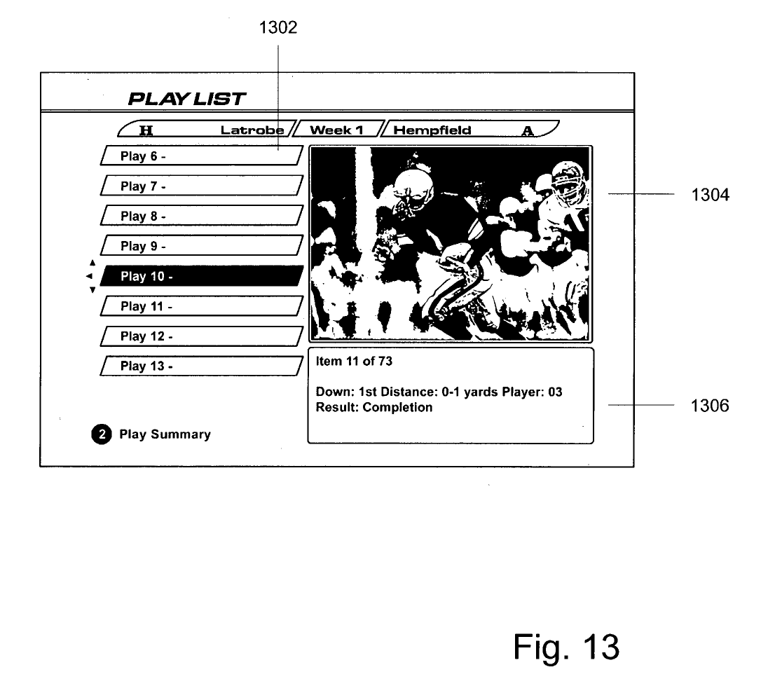

FIG. 13 illustrates a screenshot of the Play List screen 1300 of the Analyze step 110 in an exemplary embodiment of the present invention. The Play List screen 1300 may include, for example, a Play List menu 1302 that has one or more corresponding menu items, a video inset window 1304 that displays video segments from the currently selected game, and a description box 1306 that may provide text that describes a highlighted menu item. Each of the entries in the Play List menu 1302 corresponds to a video segment. A video segment may be loaded and played by selecting its corresponding menu item.

Thus, the Analyze step 110 permits the user to perform analysis upon video segments on which the Mark step 106 and the Breakdown step 108 have been performed. The values assigned to the demarcated video segments in the Breakdown step 108 are used by the Analyze step 110 to perform searches. The Video Information Analyzer 202 may return search results to the user in multiple methods. One method of organizing the search result is to display on a quarter-by-quarter basis the number of video segments that are assigned to each of the values of a searched field. A field corresponds to a menu item in the Play Breakdown menu 1002. This method is shown in FIG. 11. A second method of organization is to display all video segments that have been assigned values equal to the values selected by the user in one or more fields. This method is shown in FIG. 12. FIG. 13 shows a method of displaying a list of all video segments meeting specific search criteria and may be accessed either by selecting a gridpoint when the user chooses the method depicted in FIG. 11 or by selecting the Goto Play List option when the user chooses the method depicted in FIG. 12. Once a list of video segments is displayed, the user may make determinations as to each play's effectiveness based on the listed video segments.

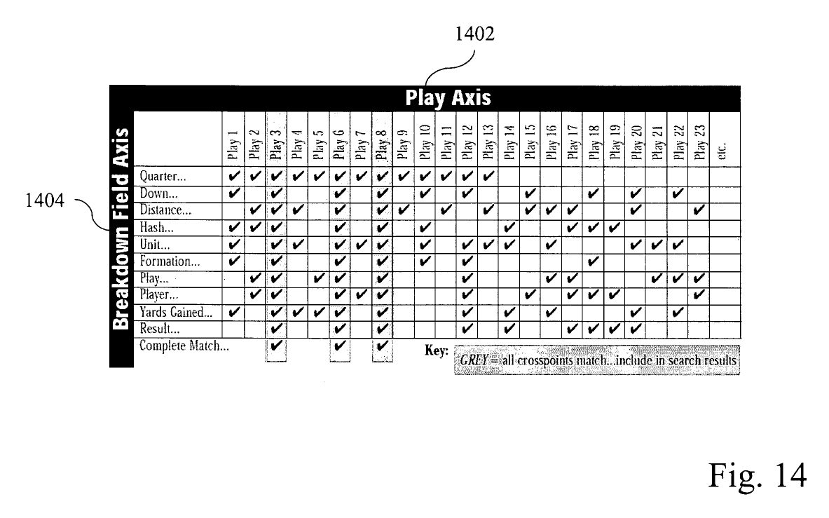

FIG. 14 illustrates a diagram of a search grid 1400 used in an exemplary embodiment of the present invention. The search grid has two axes. The first axis is the Play Axis 1402. The entries on the Play Axis 1402 represent each video segment for a currently active video file. Each video segment corresponds to a play as demarcated by the user during the Mark step 106. The second axis is the Breakdown Field Axis 1404. The entries in the Breakdown Field Axis 1404 correspond to the selections made in the Play Search menu 1202 (shown in FIG. 12). For example, the Quarter menu item 1210 in the Play Search menu 1202 may be set to 1 (for first quarter), etc. Each check in the search grid 1400 corresponds to a video segment that has been assigned a value that matches the user-selected value in the Play Search menu 1202. If all Breakdown Fields for a given video segment are checked, then the video segment is added to the Results list 1206 on the Play Search screen 1200.

The foregoing describes a scheme for analyzing video information. In the exemplary embodiment, the scheme involves setting up a video information analyzer by assigning values to one or more fields that may be used to assign reference information to video segments once a video file has been loaded. The video information analyzer then receives video input from a source device and stores it as a video file in a video storage device. The video file may be stored with reference information pertaining to the entire file, or the video file may be stored without reference information and the reference information may be added at a later time. The video file stored in the video storage device may have been demarcated before storage by the user or may have been passed through the video information analyzer. In the former case, the video file is stored as a series of video segments. In the latter case, the stored video file may be loaded into the video information analyzer to be demarcated at a later time.

After the video file has been demarcated into video segments, each video segment may be assigned reference information pertaining to an individual video segment. The reference information pertaining to a video segment may include the values set by the user for the fields described above and preset values for fields designated by the video information analyzer. After the reference information pertaining to video segments has been entered, the user may analyze the video segments based on search criteria corresponding to the assigned reference information. The reference information may be displayed as a grid of the number of video segments matching one or more search criteria or as a listing of all video segments matching one or more search criteria. The user may then analyze the video segments matching the search criteria by viewing the plays.

Thus, the system permits a user to modify the sequence or selection of the video input stream by assigning reference points when storing the digital video file. Furthermore, the system allows the user to create user-defined fields, in addition to system preset fields, to demarcate video segments in the stored digital video file. Moreover, the system allows a user to directly access a demarcated video segment by searching for and selecting the demarcated video segment from a list of all demarcated video segments or all demarcated video segments possessing specified reference information.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method of processing video information comprising:
specifying a plurality of fields to be used to classify said video information, wherein each of said plurality of fields contains one or more user-selectable values;
receiving a video input containing said video information;
marking said video input to divide said video input into a plurality of video segments;
allowing a first user to specify said one or more user-selectable values for each of said plurality of fields;
classifying each of said plurality of video segments into one or more of said plurality of fields using corresponding one or more user-selectable values specified by said first user for each said field used for classification; and
storing each classified video segment along with corresponding one or more user-selectable values in a database.

2. The method of claim 1 further comprising:
receiving an input specified by a second user specifying said one or more user-selectable values for one or more of said plurality of fields;
for each classified video segment, searching said, database to identify one or more corresponding fields whose respective one or more user-selectable values match said input specified by said second user; and
selecting each said classified video segment for which each of said one or more corresponding fields has one or more user-selectable values matching said input specified by said second user for said corresponding field.

3. The method of claim 1 further comprising:
receiving an input specified by a second user specifying at least one of said one or more user-selectable values for one or more of said plurality of fields;
for each classified video segment, searching said database to identify one or more corresponding fields whose respective one or more user-selectable values matches said input specified by said second user; and
displaying an index of each said classified video segment for which each of said one or more corresponding fields has respective one or more user-selectable values matching said input specified by said second user for said one or more corresponding fields.

4. The method of claim 3, wherein displaying an index of each said classified video segment comprises:
for each classified video segment, searching said database for said respective one or more user-selectable values from said one or more corresponding fields;
summing one or more quantities of classified video segments, wherein each of said one or more quantities equals the number of said classified video segments for which each of said respective one or more user-selectable values from said one or more corresponding fields are the same; and
displaying a grid containing said one or more quantities, wherein said grid is indexed by said respective one or more user-selectable values from said one or more corresponding fields.

5. The method of claim 4 further comprising:
selecting at least one of said one or more quantities; and
displaying a list of one or more of said classified video segments corresponding to each selected quantity.

6. The method of claim 1, wherein receiving said video input comprises:
receiving said video input in an analog form; and
converting said video input in said analog form into a digital form prior to marking said video input.

7. The method of claim 1, wherein receiving said video input comprises:
receiving said video input in a first digital form; and
converting said video input in said first digital form into a second digital form prior to marking said video input.

8. The method of claim 1, wherein receiving said video input comprises performing at least one of the following:
storing said video input in a digital form, wherein a resolution of said digital form is user-selectable;
storing said video input along with information specified by said first user for one or more predetermined parameters selected by said first user to identify said video input; and
storing said video input along with accompanying audio.

9. The method of claim 8, wherein said digital form comprises an MPEG (Moving Pictures Expert Group) file.

10. The method of claim 1, wherein marking said video input comprises performing at least one of the following:
allowing a third user to mark said video input manually prior to receiving said video input;
allowing a fourth user to mark said video input electronically while receiving said video input; and
allowing a fifth user to mark said video input electronically after storing said video input.

11. The method of claim 1 further comprising:
generating an indexing file for one or more classified video segments; and
storing said indexing file for all said classified video segments in said database.

12. A system for processing video information comprising:
a processor;
a video source device which provides a video input to said processor;
a memory which is operatively coupled to said processor; and
a computer program stored in said memory which executes in said processor and which comprises:
a marker module configured to mark said video input,
a storer module configured to store one or more video files containing said marked video input in said memory, and
an analyzer module configured to analyze said one or more video files stored in said memory.

13. An apparatus for processing video information comprising:
means for specifying a plurality of fields to be used to classify said video information, wherein each of said plurality of fields contains one or more user-selectable values;
means for receiving a video input containing said video information;
means for marking said video input to divide said video input into a plurality of video segments;
means for allowing a first user to specify said one or more user-selectable values for each of said plurality of fields;
means for classifying each of said plurality of video segments into one or more of said plurality of fields using corresponding one or more user-selectable values specified by said first user for each said field used for classification; and
means for storing each classified video segment along with corresponding one or more user-selectable values in a database.

14. The apparatus of claim 13 further comprising:
means for receiving an input specified by a second user specifying said one or more user-selectable values for one or more of said plurality of fields;
for each classified video segment, means for searching said database to identify one or more corresponding fields whose respective one or more user-selectable values match said input specified by said second user; and
means for selecting each said classified video segment for which each of said one or more corresponding fields has respective one or more user-selectable values matching said input specified by said second user for said corresponding field.

15. The apparatus of claim 13 further comprising:
means for receiving an input specified by a second user specifying at least one of said one or more user-selectable values for one of said plurality of fields;
for each classified video segment, means for searching said database to identify one or more corresponding fields whose respective one or more user-selectable values match said input specified by said second user; and
for each classified video segment, means for searching said database for said respective one or more user-selectable values from said one or more corresponding fields;
means for summing one or more quantities of classified video segments, wherein each of said one or more quantities equals the number of said classified video segments for which each of said respective one or more user-selectable values from said one or more corresponding fields are the same; and
means for displaying a grid containing said one or more quantities, wherein said grid is indexed by said respective one or more user-selectable values from said one or more corresponding fields.

16. The apparatus of claim 15 further comprising:
means for selecting at least one of said one or more quantities; and
means for displaying a list of one or more of said classified video segments corresponding to each selected quantity.

17. The apparatus of claim 13, wherein said means for receiving said video input comprises at least one of the following:
a first means including:
means for receiving said video input in an analog form, and
means for converting said video input in said analog form into a digital form prior to marking said video input; and
a second means including:
means for receiving said video input in a first digital form, and
means for converting said video input in said first digital form into a second digital form prior to marking said video input.

18. The apparatus of claim 13, wherein said means for receiving said video input comprises performing at least one of the following:
means for storing said video input in a digital form, wherein a resolution of said digital form is user-selectable;
means for storing said video input along with information specified by said first user for one or more predetermined parameters selected by said first user to identify said video input; and
means for storing said video input along with accompanying audio in said digital form.

19. The apparatus of claim 13, wherein said means for marking said video input comprises performing at least one of the following:
means for allowing a third user to mark said video input manually prior to receiving said video input;
means for allowing a fourth user to mark said video input electronically while receiving said video input; and
means for allowing a fifth user to mark said video input electronically after storing said video input.

20. The apparatus of claim 13 further comprising:
means for generating an indexing file for one or more classified video segments; and
means for storing said indexing file for all said classified video segments in said database.

21. A computer-readable storage medium containing a program code, which, upon execution by a processor in a video information analyzer, causes said processor to perform the following:
specify a plurality of fields to be used to classify said video information, wherein each of said plurality of fields contains one or more user-selectable values;
receive a video input containing said video information;
mark said video input to divide said video input into a plurality of video segments;
allow a first user to specify said one or more user-selectable values for each of said plurality of fields;
classify each of said plurality of video segments into one or more of said plurality of fields using corresponding one or more user-selectable values specified by said first user for each said field used for classification; and
store each classified video segment along with corresponding one or more user-selectable values in a database.
